(19) United States
(12) Patent Application Publication
(10) Pub. No.: US 2026/0191727 A1
(43) Pub. Date: Jul. 9, 2026

(54) NESTED ELASTIC MEMBER-DRIVEN FINGER REHABILITATION DEVICE AND HAND REHABILITATION DEVICE

(71) Applicant: Nanchang University, Nanchang (CN)

(72) Inventors: Zhiwei MAO, Nanchang (CN); Wei ZHANG, Nanchang (CN); Shufeng WANG, Nanchang (CN); Wenjun LI, Nanchang (CN); Lixu LIU, Nanchang (CN)

(21) Appl. No.: 19/432,775

(22) Filed: Dec. 24, 2025

(30) Foreign Application Priority Data
Jan. 9, 2025 (CN) 202510035004.1

(51) Int. Cl. A61H 1/02

(52) U.S. Cl. CPC A61H 1/0288; A61H 2201/0192; A61H 2201/1207; A61H 2201/1238; A61H 2201/14; A61H 2201/1635; A61H 2201/165; A61H 2201/1664; A61H 2201/1676

(57) ABSTRACT

The present disclosure relates to the field of finger rehabilitation and provides a nested elastic member-driven finger rehabilitation device and hand rehabilitation device. The nested elastic member-driven finger rehabilitation device includes: an elastic driving member disposed on one side close to the back of a hand and capable of telescopic and flexion-extension movements, a palm connection assembly configured to be connected to a palm and the elastic driving member, and a finger joint connection assembly configured to be connected to a finger joint and the elastic driving member, where the elastic driving member has the following working states: a bending state and an extension state. In the bending state, the elastic driving member extends and bends toward the palm. In the extension state, the elastic driving member retracts and extends away from the palm.

### CROSS-REFERENCE TO RELATED APPLICATIONS

The present application claims priority to Chinese patent application No. 202510035004.1, titled “NESTED ELASTIC MEMBER-DRIVEN FINGER REHABILITATION DEVICE AND HAND REHABILITATION DEVICE”, filed on 9 January 2025, the entire contents of which are incorporated herein by reference.

### FIELD OF TECHNOLOGY

The present disclosure relates to the technical field of finger rehabilitation, and specifically, to a nested elastic member-driven finger rehabilitation device. On this basis, it further relates to a nested elastic member-driven hand rehabilitation device.

### BACKGROUND

Conventional hand rehabilitation therapy mainly relies on manual operation by physical therapists, so this approach is not only time-consuming and labor-intensive, but also fails to ensure the accuracy and consistency of treatment. Therefore, it is of significant clinical importance and application value to develop a robotic device that can assist in hand rehabilitation and achieve the automation and precision of the rehabilitation process.

Research on hand exoskeletons was initially applied in the field of master-slave operation, such as robotic hand control for astronauts' extravehicular activities. With the continuous advancement of technology, hand exoskeletons have been gradually applied in the field of rehabilitation engineering, becoming an important auxiliary tool for hand rehabilitation.

Technical solutions for hand exoskeletons are mainly divided into three major categories: soft exoskeletons, soft-rigid hybrid hand exoskeletons, and rigid hand exoskeletons.

The soft hand exoskeletons feature good flexibility, relatively small structural dimensions, and can fit the hand well. However, their close fit to the hand leads to a short force arm for driving the rotation of finger joints and a low ratio of rotating torque to driving force of the joint. There are mainly two types: cable-driven and pneumatic-driven. The cable-driven type can only provide tensile force, and each joint needs to be driven by one or two driving motors in conjunction with auxiliary pulleys, resulting in complex overall wiring, poor hand size compatibility, the necessity for customization based on hand sizes of patients, excessive overall weight, and high manufacturing costs. Compared with the cable-driven type, the pneumatic-driven type has better hand size compatibility, but features a lower ratio of driving torque to driving force of the finger joint, a small gripping force, and poor position and speed servo control accuracy.

The soft-rigid hybrid hand exoskeletons cannot independently control the movement of each finger joint. Compared with the physiological structure of the finger, they greatly reduce finger flexibility, allow for fewer hand postures, and cannot perform a variety of rehabilitation movements. Since the driving force acts on the distal finger joint, the joint has a low ratio of rotating torque to driving force, resulting in a small gripping force. More seriously, due to the large force component of the driving force in the direction perpendicular to the rotation axis of the joint, high pressure is exerted on the three finger joints, which easily causes joint injury. Secondly, the soft-rigid hybrid hand exoskeletons have high rigidity in the direction perpendicular to the joint rotation during finger flexion and extension, which imposes strict restrictions on finger abduction and adduction. Moreover, misalignment during wear causes discomfort to patients.

The rigid hand exoskeletons represented by linkage mechanisms feature a large number of structural members, large size, large movement space, and heavy weight. Additionally, it is difficult to align the kinematic pairs of the mechanism with the joints, which is prone to misalignment, thus causing discomfort to patients and even joint injuries. The rigid hand exoskeletons have poor hand size compatibility, so when the hand size varies among different patients, the members in the mechanism usually need to be replaced for adaptation. In addition, since the finger joint have as many as twenty-one degrees of freedom, the rigid hand exoskeleton mechanism imposes strict constraints on the degrees of freedom of the joint except those under control. This is detrimental to hand rehabilitation training when patients have a certain degree of motor ability in the constrained degrees of freedom.

### SUMMARY

To solve at least one of the above-mentioned technical problems in the prior art, an objective of the present disclosure is to provide a nested elastic member-driven finger rehabilitation device and hand rehabilitation device. The nested elastic member-driven finger rehabilitation device has the advantages of good finger protection performance, strong compatibility with hand sizes, and the like.

To achieve the above objective, a first aspect of the present disclosure provides a nested elastic member-driven finger rehabilitation device, including: an elastic driving member disposed on one side close to the back of a hand and capable of telescopic and flexion-extension movements, a palm connection assembly configured to be connected to a palm and the elastic driving member, and a finger joint connection assembly configured to be connected to a finger joint and the elastic driving member, where the elastic driving member has the following working states: a bending state, in which the elastic driving member extends to increase a curve length between the palm connection assembly and the finger joint connection assembly, and the elastic driving member bends toward the palm; and an extension state, in which the elastic driving member retracts to shorten the curve length between the palm connection assembly and the finger joint connection assembly, and the elastic driving member extends away from the palm.

In the above technical solution, the palm connection assembly is connected to the palm and the elastic driving member, and the finger joint connection assembly is connected to the finger joint (such as a distal finger joint, a middle finger joint, or a proximal finger joint) and the elastic driving member. When the elastic driving member extends, the curve length between the palm connection assembly and the finger joint connection assembly increases, such that the elastic driving member bends toward the palm and drives a finger to flex around the palm, thereby achieving finger flexion. When the elastic driving member retracts, the curve length between the palm connection assembly and the finger joint connection assembly decreases, such that the elastic driving member bends away from the palm and drives the finger to extend around the palm.

In the finger rehabilitation device according to the present disclosure, the finger joint connection assembly is connected to the finger joint and does not need to be aligned with the finger joint, which facilitates wearing. Compared with the solution in the prior art where the connection assembly is aligned with the finger joint in the prior art, the connection between the finger joint connection assembly and the finger joint is relatively easy to achieve, and misalignment is less likely to occur during use, which would otherwise cause user discomfort or even finger joint injury. Moreover, the finger rehabilitation device has good compatibility with different hand sizes. When the hand sizes of different users change, there is no need to customize or replace components in the finger rehabilitation device, thus saving economic costs. Furthermore, as described above, the elastic driving member extends to increase the curve length between the palm connection assembly and the finger joint connection assembly, thereby achieving finger flexion. In this way, by increasing the lengths of the elastic driving members between the connection assemblies corresponding to different finger joints and the palm connection assembly, the different finger joints can be flexed to meet different rehabilitation therapy requirements. On this basis, the finger rehabilitation device according to the present disclosure can also independently control flexion of the different finger joints, thereby achieving more hand postures.

Additionally, in the prior art, a non-elastic driving member such as a steel cable is generally used to drive finger flexion. When the driving member applies an excessive driving force to the non-elastic member, the non-elastic member applies an excessive force to the finger during bending, which easily causes finger injury. However, the finger rehabilitation device according to the present disclosure uses the elastic driving member to drive the finger flexion. Since the elastic driving member itself has a certain elasticity, it can buffer part of the excessive driving force during bending, thereby protecting the finger joint.

In some embodiments, the finger joint connection assembly includes a distal finger joint fixing seat connected to the elastic driving member and a distal finger joint, a middle finger joint fixing seat connected to the elastic driving member and a middle finger joint, and a proximal finger joint fixing seat connected to the elastic driving member and a proximal finger joint.

In some embodiments, the middle finger joint fixing seat, the proximal finger joint fixing seat, and the palm connection assembly are respectively provided with a middle joint mounting hole, a proximal joint mounting hole, and a proximal finger joint mounting hole for mounting the elastic driving member, and centerlines of the middle joint mounting hole, the proximal joint mounting hole, and the proximal finger joint mounting hole are all in an arc shape, with a center located on the side close to the back of the hand.

In some embodiments, the middle joint mounting hole, the proximal joint mounting hole, and the proximal finger joint mounting hole are rotatably connected to the elastic driving member.

In some embodiments, the elastic driving member includes a first elastic driving member with an end connected to the distal finger joint fixing seat, a second elastic driving member with an end connected to the middle finger joint fixing seat, and a third elastic driving member with an end connected to the proximal finger joint fixing seat.

In some embodiments, the first elastic driving member is an elastic driving rod, the second elastic driving member is a first elastic driving tube sleeved on the elastic driving rod, and the third elastic driving member is a second elastic driving tube sleeved on the first elastic driving tube.

In some embodiments, the finger rehabilitation device further includes an elastic telescopic assembly sleeved on the elastic driving member, where the elastic telescopic assembly includes a first elastic telescopic member disposed between the distal finger joint fixing seat and the middle finger joint fixing seat, a second elastic telescopic member disposed between the middle finger joint fixing seat and the proximal finger joint fixing seat, and a third elastic telescopic member disposed between the proximal finger joint fixing seat and the palm connection assembly.

In some embodiments, the finger rehabilitation device further includes a rope assembly, with one end connected to the palm connection assembly or the finger joint connection assembly, and the other end connected to one side of the elastic telescopic assembly close to a finger surface.

In some embodiments, the finger rehabilitation device further includes a driving box in transmission connection with the elastic driving member, and an elastic connecting tube connected between the driving box and the palm connection assembly, where the elastic connecting tube is sleeved on the elastic driving member.

In some embodiments, the elastic driving member is made of polytetrafluoroethylene.

A second aspect of the present disclosure provides a nested elastic member-driven hand rehabilitation device, including a plurality of nested elastic member-driven finger rehabilitation devices described above, where the plurality of finger rehabilitation devices are correspondingly mounted on different fingers.

Other features and advantages of the embodiments of the present disclosure will be described in detail in the subsequent specific embodiments.

### BRIEF DESCRIPTION OF THE DRAWINGS

FIG. 1 is a schematic structural diagram of a nested elastic member-driven finger rehabilitation device according to the present disclosure;

FIG. 2 is a cross-sectional view of a finger rehabilitation device in FIG. 1;

FIG. 3 is a schematic diagram of a connecting structure of a finger rehabilitation device at a distal finger joint according to the present disclosure;

FIG. 4 is a schematic diagram of a connecting structure of a finger rehabilitation device at a middle finger joint and a proximal finger joint according to the present disclosure;

FIG. 5 is a schematic diagram of a connecting structure of a finger rehabilitation device at a palm according to the present disclosure;

FIG. 6 is a schematic structural diagram of one embodiment of a finger rehabilitation device according to the present disclosure;

FIG. 7 is a schematic structural diagram of another embodiment of a finger rehabilitation device according to the present disclosure; and

FIG. 8 is a schematic structural diagram of yet another embodiment of a finger rehabilitation device according to the present disclosure.

### DESCRIPTION OF THE EMBODIMENTS

The following provides a detailed description of the specific embodiments of the present disclosure with reference to the accompanying drawings. It should be understood that the specific embodiments described herein are only for illustrating and explaining the present disclosure and are not intended to limit the present disclosure.

In the present disclosure, unless otherwise stated, the terms "upper, lower, left, right, inner, outer, top, bottom," etc. indicate orientations or positional relationships based on the orientations or positional relationships shown in the accompanying drawings, merely for the convenience of describing the present disclosure and simplifying the description, rather than indicating or implying that the device or element referred to must have a particular orientation or be constructed and operated in a particular orientation, and therefore cannot be understood as limiting the present disclosure.

In addition, the terms "first", "second" and the like are only used for descriptive purposes, and should not be construed as indicating or implying relative importance or implicitly indicating the number of technical features indicated. Thus, features defined with "first" and "second" can explicitly or implicitly include at least one of the features. In the description of the present disclosure, "a plurality of" means at least two, for example, two, three, etc., unless otherwise specifically defined.

In the present disclosure, the description with reference to the terms "one embodiment", "some embodiments", "an example", "a specific example", or "some examples" refers to that the specific features, structures, materials, or characteristics described in combination with the embodiment or example are included in at least one embodiment or example of the present disclosure. In this specification, schematic representations of the above terms need not be directed to the same embodiments or examples. Moreover, the specific features, structures, materials or characteristics described may be combined in a suitable manner in any one or more embodiments or examples. In addition, different embodiments or examples described in this specification and features of different embodiments or examples may be connected and combined by those skilled in the art without mutual contradiction.

In the present disclosure, the terms such as "mount", "connected", "connection", and "fix" should be understood in a broad sense, unless otherwise expressly specified and limited. For example, it may be a fixed connection, a detachable connection, or being integrated; it may be a mechanical connection or an electrical connection; and it may be being directly connected, being indirectly connected via an intermediate medium, a communication between the interiors of two elements, or an interaction between two elements. Those of ordinary skill in the art can understand specific meanings of the above terms in the present disclosure according to specific circumstances.

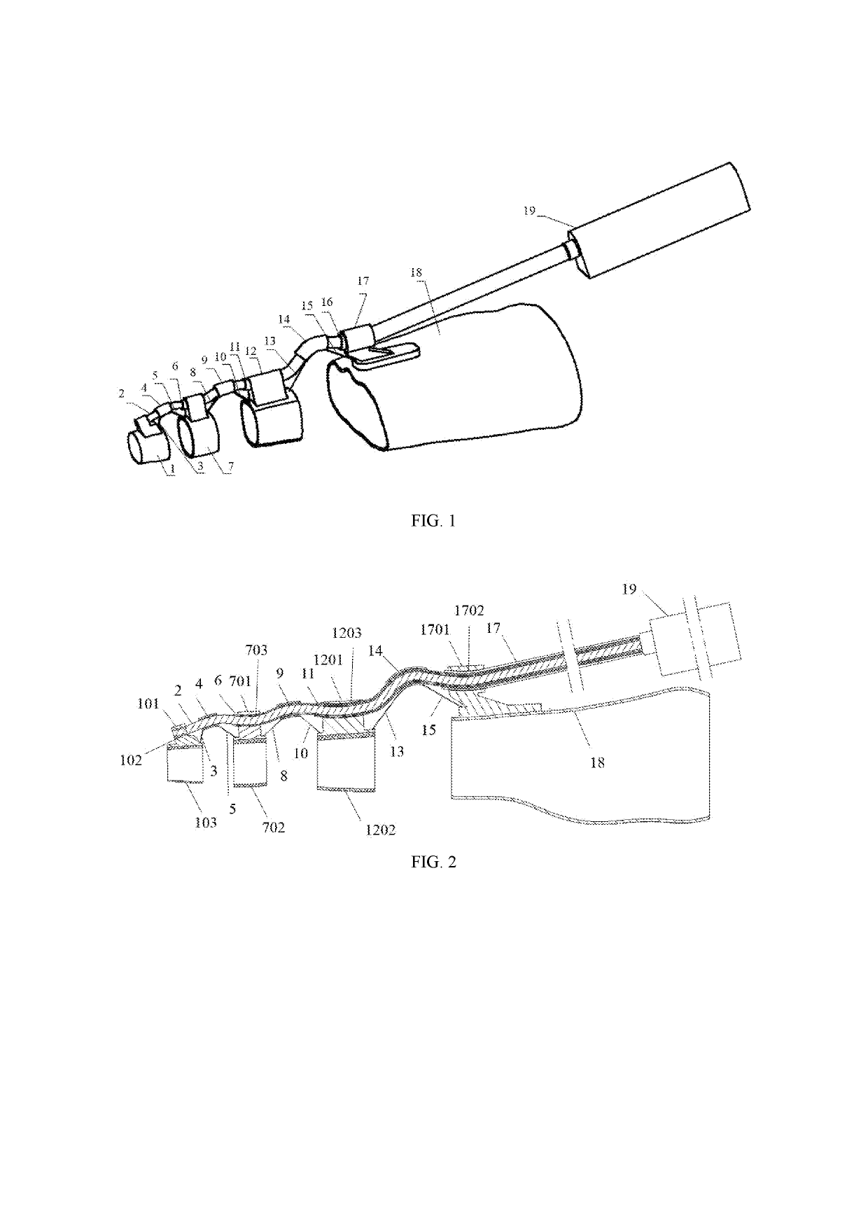

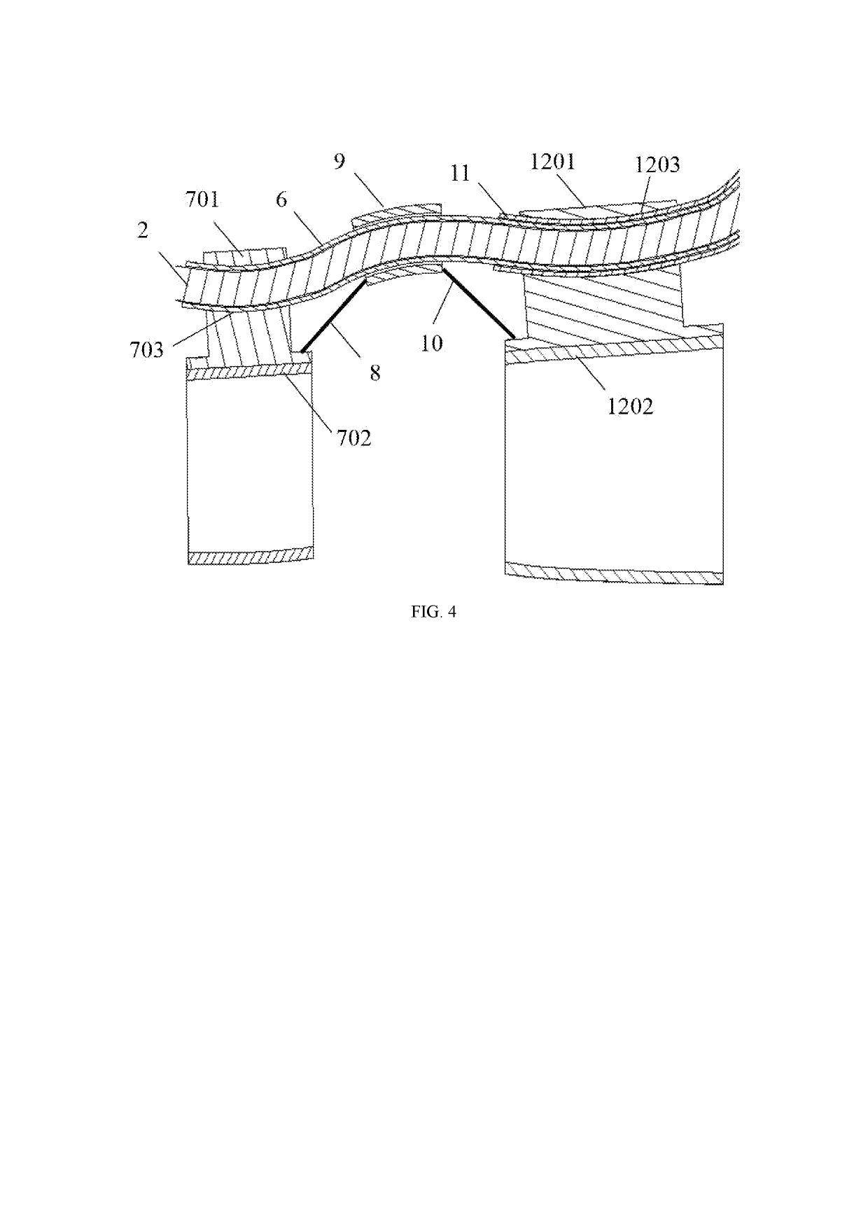

A first aspect of the present disclosure provides a nested elastic member-driven finger rehabilitation device. With reference to FIG. 1 to FIG. 8, the finger rehabilitation device includes: an elastic driving member disposed on one side close to the back of a hand, a palm connection assembly 17 configured to be connected to the elastic driving member and a palm, and a finger joint connection assembly configured to be connected to a finger joint and the elastic driving member. The elastic driving member is configured to be capable of telescopic and flexion-extension movements, where the elastic driving member has the following working states:

a bending state, in which the elastic driving member extends to increase a curve length between the palm connection assembly 17 and the finger joint connection assembly, and the elastic driving member bends toward the palm; and an extension state, in which the elastic driving member retracts to shorten the curve length between the palm connection assembly 17 and the finger joint connection assembly, and the elastic driving member extends away from the palm.

In the above technical solution, the palm connection assembly 17 is connected to the palm and the elastic driving member, and the finger joint connection assembly is connected to the finger joint (such as a distal finger joint, a middle finger joint, or a proximal finger joint) and the elastic driving member. When the elastic driving member extends, the curve length between the palm connection assembly 17 and the finger joint connection assembly increases, such that the elastic driving member bends toward the palm and drives a finger to flex around the palm, thereby achieving finger flexion. When the elastic driving member retracts, the curve length between the palm connection assembly 17 and the finger joint connection assembly decreases, such that the elastic driving member bends away from the palm and drives the finger to extend around the palm.

In the finger rehabilitation device according to the present disclosure, the finger joint connection assembly is connected to the finger joint and does not need to be aligned with the finger joint, which facilitates wearing. Compared with the solution in the prior art where the connection assembly is aligned with the finger joint in the prior art, the connection between the finger joint connection assembly and the finger joint is relatively easy to achieve, and misalignment is less likely to occur during use, which would otherwise cause user discomfort or even finger joint injury. Moreover, the finger rehabilitation device has good compatibility with different hand sizes. When the hand sizes of different users change, there is no need to customize or replace components in the finger rehabilitation device, thus saving economic costs. Furthermore, as described above, the elastic driving member extends to increase the curve length between the palm connection assembly 17 and the finger joint connection assembly, thereby achieving finger flexion. In this way, by increasing the lengths of the elastic driving members between the connection assemblies corresponding to different finger joints and the palm connection assembly 17, the different finger joints can be flexed to meet different rehabilitation therapy requirements. On this basis, the finger rehabilitation device according to the present disclosure can also independently control flexion of the different finger joints, thereby achieving more hand postures.

Additionally, in the prior art, a non-elastic driving member such as a steel cable is generally used to drive finger flexion. When the driving member applies an excessive driving force to the non-elastic member, the non-elastic member applies an excessive force to the finger during bending, which easily causes finger injury. However, the finger rehabilitation device according to the present disclosure uses the elastic driving member to drive the finger flexion. Since the elastic driving member itself has a certain elasticity, it can buffer part of the excessive driving force during bending, thereby protecting the finger joint.

In some embodiments, the finger joint connection assembly includes a distal finger joint fixing seat 1 connected to the elastic driving member and a distal finger joint, a middle finger joint fixing seat 7 connected to the elastic driving member and a middle finger joint, and a proximal finger joint fixing seat 12 connected to the elastic driving member and a proximal finger joint.

In some embodiments, the elastic driving member includes a first elastic driving member with an end connected to the distal finger joint fixing seat 1, a second elastic driving member with an end connected to the middle finger joint fixing seat 7, and a third elastic driving member with an end connected to the proximal finger joint fixing seat 12.

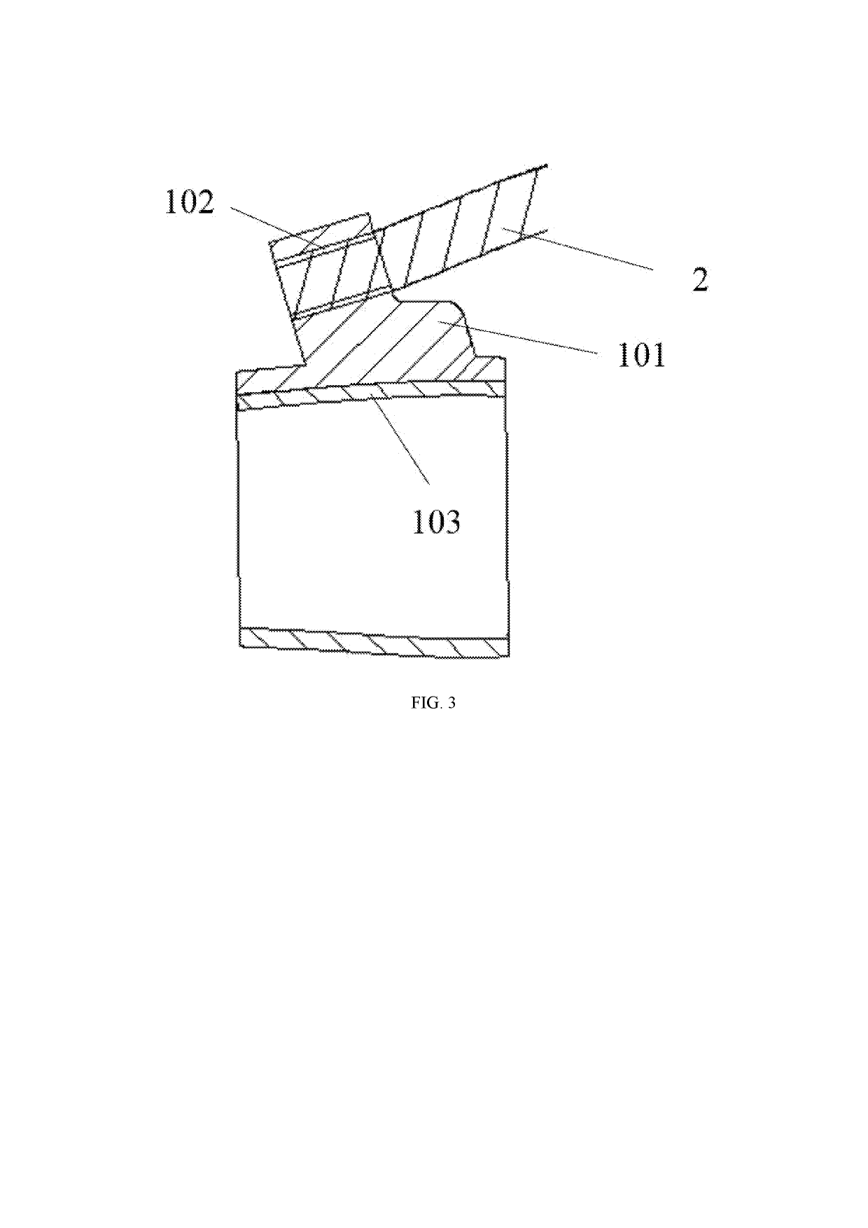

In some embodiments, various connecting structures can be used among the first elastic driving member, the second elastic driving member, and the third elastic driving member. For example, a parallel connecting structure is used, that is, the first elastic driving member, the second elastic driving member, and the third elastic driving member are disposed in parallel above a finger surface. Alternatively, according to one embodiment of the nested elastic member-driven finger rehabilitation device in the present disclosure, a nested connecting structure is used among the first elastic driving member, the second elastic driving member, and the third elastic driving member. With reference to FIG. 1 and FIG. 2, the first elastic driving member is an elastic driving rod 2, the second elastic driving member is a first elastic driving tube 6 sleeved on the elastic driving rod 2, and the third elastic driving member is a second elastic driving tube 11 sleeved on the first elastic driving tube 6. In this way, on the one hand, the structure of the finger rehabilitation device can be simplified, making the structure compact; and on the other hand, the second elastic driving member and the third elastic driving member are configured as hollow tubes, which helps to reduce the driving force required for their extension, retraction, and bending.

In some embodiments, the middle finger joint fixing seat 7, the proximal finger joint fixing seat 12, and the palm connection assembly 17 are respectively provided with a middle joint mounting hole 703, a proximal joint mounting hole 1203, and a proximal finger joint mounting hole 1702 for mounting the elastic driving member, and centerlines of the middle joint mounting hole 703, the proximal joint mounting hole 1203, and the proximal finger joint mounting hole 1702 are all in an arc shape, with a center located on the side close to the back of the hand. In this way, when extending toward the distal finger joint, the elastic driving member bends and rotates away from the back of the hand at outlets of the middle joint mounting hole 703, the proximal joint mounting hole 1203, and the proximal finger joint mounting hole 1702, thus preventing it from deforming toward the finger surface to cause finger injury, and increasing a driving torque of the finger joint.

In some embodiments, the middle joint mounting hole 703, the proximal joint mounting hole 1203, and the proximal finger joint mounting hole 1702 are rotatably connected to the elastic driving member. In this way, the position of the elastic driving member during mounting or telescopic movement can be conveniently adjusted. For example, if the elastic driving member twists or spirals during mounting, such twisting or spiraling can be eliminated by rotating the elastic driving member, thereby ensuring the mounting quality of the elastic driving member.

In some embodiments, the finger rehabilitation device further includes an elastic telescopic assembly sleeved on the elastic driving member, where the elastic telescopic assembly includes a first elastic telescopic member 4 disposed between the distal finger joint fixing seat 1 and the middle finger joint fixing seat 7, a second elastic telescopic member 9 disposed between the middle finger joint fixing seat 7 and the proximal finger joint fixing seat 12, and a third elastic telescopic member 14 disposed between the proximal finger joint fixing seat 12 and the palm connection assembly 17. The elastic telescopic assembly has a certain telescopic range, and can limit the extension or retraction length of the elastic driving member to prevent excessive extension or retraction length of the elastic driving member which may cause finger injury.

In some embodiments, the finger rehabilitation device further includes a rope assembly, with one end connected to the palm connection assembly 17 or the finger joint connection assembly, and the other end connected to one side of the elastic telescopic assembly close to a finger surface. The rope assembly further limits the extension or retraction length of the elastic driving member, thus providing further protection for the finger.

In some embodiments, the finger rehabilitation device further includes a driving box 19 in transmission connection with the elastic driving member, and an elastic connecting tube 16 connected between the driving box 19 and the palm connection assembly 17, where the elastic connecting tube 16 is sleeved on the elastic driving member. In some other embodiments, the finger of the user has a certain degree of motor ability, such that the elastic driving member can be driven to extend and flex by the finger itself; or the elastic driving member can be driven to extend and flex manually. The driving box 19 may include one or a combination of an electric motor, a hydraulic machine, and a pneumatic machine.

In some embodiments, the elastic driving member and the elastic connecting tube 16 are made of polytetrafluoroethylene, such that the resistance generated by the elastic driving member during bending and rotation is reduced, thereby reducing the required driving torque. Moreover, the elastic driving member made of polytetrafluoroethylene results in light weight and low manufacturing costs of the finger rehabilitation device.

It should be noted that the elastic driving member can deform by bending around a rotation axis of the finger joint, such as bending and rotating toward or away from the palm, and can also deform around a direction perpendicular to a joint rotation direction, such as driving the finger to perform abduction and adduction movements, that is, wearing the finger rehabilitation device according to the present disclosure allows for a certain degree of abduction and adduction between the fingers of the hand.

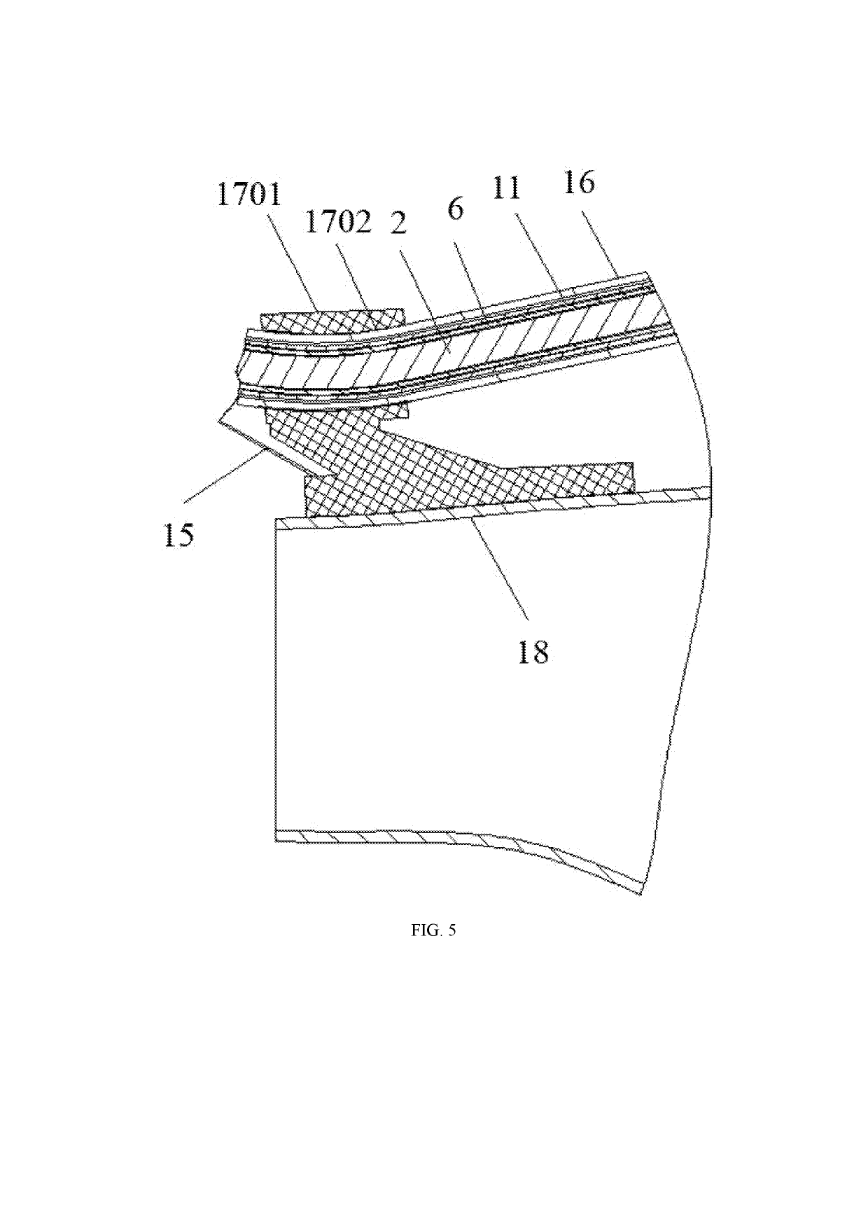

One embodiment of the elastic driving member-driven finger rehabilitation device according to the present disclosure is described in detail below with reference to FIG. 1 to FIG. 5. The elastic driving member includes an elastic driving rod 2, a first elastic driving tube 6, and a second elastic driving tube 11 that are nested on one side from inside to outside, where one end of the elastic driving rod 2, one end of the first elastic driving tube 6, and one end of the second elastic driving tube 11 are all in transmission connection with the driving box 19, and the driving box 19 is configured to drive extension and retraction of the elastic driving rod 2, the first elastic driving tube 6, and the second elastic driving tube 11. An elastic connecting tube 16 is disposed between the driving box 19 and the palm connection assembly 17, and the elastic connecting tube 16 is sleeved on the second elastic driving tube 11 to connect the driving box 19 to the palm connection assembly 17. With reference to FIG. 5, the palm connection assembly 17 includes a glove 18 configured to be connected to the palm, and a proximal finger joint fixing seat 1701 connected to an upper portion of the glove 18. The proximal finger joint fixing seat 1701 is provided with a proximal finger joint mounting hole 1702. The proximal finger joint mounting hole 1702 is sleeved on an outer peripheral wall of the elastic connecting tube 16. The proximal finger joint mounting hole 1702 can be adhesively connected.

With reference to FIG. 1 to FIG. 4, the finger joint connection assembly includes a distal finger joint fixing seat 1, a middle finger joint fixing seat 7, and a proximal finger joint fixing seat 12. The distal finger joint fixing seat 1 includes a distal finger joint base 101 and a distal finger joint flexible sleeve 103 adhered to a lower portion of the distal finger joint base 101. The distal finger joint flexible sleeve 103 is configured to be sleeved on the distal finger joint. The distal finger joint base 101 is provided with a mounting hole connected to an end of the elastic driving rod 2. A wall surface of the mounting hole is provided with a thread 102, such that the distal finger joint base 101 can be threadedly connected to the elastic driving rod 2. The middle finger joint fixing seat 7 includes a middle finger joint base 701 and a middle finger joint flexible sleeve 702 connected to a lower portion of the middle finger joint base 701. The middle finger joint flexible sleeve 702 is configured to be sleeved on the middle finger joint. The middle finger joint base 701 is provided with a middle joint mounting hole 703 connected to an end of the first elastic driving tube 6. The end of the first elastic driving tube 6 can be adhesively connected to the middle joint mounting hole 703. The proximal finger joint fixing seat 12 includes a proximal finger joint base 1201 and a proximal finger joint flexible sleeve 1202 connected to a lower portion of the proximal finger joint base 1201. The proximal finger joint flexible sleeve 1202 is configured to be sleeved on the proximal finger joint. The proximal finger joint base 1201 is provided with a proximal joint mounting hole 1203 connected to an end of the second elastic driving tube 11. The end of the second elastic driving tube 11 can be adhesively connected to the proximal joint mounting hole 1203.

With reference to FIG. 1 to FIG. 5, the elastic telescopic assembly includes a first elastic telescopic member 4, a second elastic telescopic member 9, and a third elastic telescopic member 14. The rope assembly includes a first rope 3, a second rope 5, a third rope 8, a fourth rope 10, a fifth rope 13, and a sixth rope 15. The first elastic telescopic member 4 is sleeved on an outer peripheral wall of the elastic driving rod 2 between the distal finger joint fixing seat 1 and the middle finger joint fixing seat 7. Two ends of the first rope 3 are connected to the distal finger joint base 101 and the first elastic telescopic member 4, respectively. Two ends of the second rope 5 are connected to the middle finger joint base 701 and the first elastic telescopic member 4, respectively. Specifically, the first rope 3 is connected to an end of the first elastic telescopic member 4 close to the distal finger joint base 101 and the finger surface, and the second rope 5 is connected to an end of the first elastic telescopic member 4 close to the middle finger joint base 701 and the finger surface. The second elastic telescopic member 9 is sleeved on an outer peripheral wall of the first elastic driving tube 6 between the middle finger joint fixing seat 7 and the proximal finger joint fixing seat 12. Two ends of the third rope 8 are connected to the middle finger joint base 701 and the second elastic telescopic member 9, respectively. Two ends of the fourth rope 10 are connected to the proximal finger joint base 1201 and the second elastic telescopic member 9, respectively. Specifically, the third rope 8 is connected to an end of the second elastic telescopic member 9 close to the middle finger joint base 701 and the finger surface, and the fourth rope 10 is connected to an end of the second elastic telescopic member 9 close to the proximal finger joint base 1201 and the finger surface. The third elastic telescopic member 14 is sleeved on an outer peripheral wall of the second elastic driving tube 11 between the proximal finger joint fixing seat 12 and the palm connection assembly 17. Two ends of the fifth rope 13 are connected to the proximal finger joint base 1201 and the third elastic telescopic member 14, respectively. Two ends of the sixth rope 15 are connected to the proximal finger joint fixing seat 1701 and the third elastic telescopic member 14, respectively. Specifically, the fifth rope 13 is connected to an end of the third elastic telescopic member 14 close to the proximal finger joint base 1201 and the finger surface, and the sixth rope 15 is connected to an end of the third elastic telescopic member 14 close to the proximal finger joint fixing seat 1701 and the finger surface.

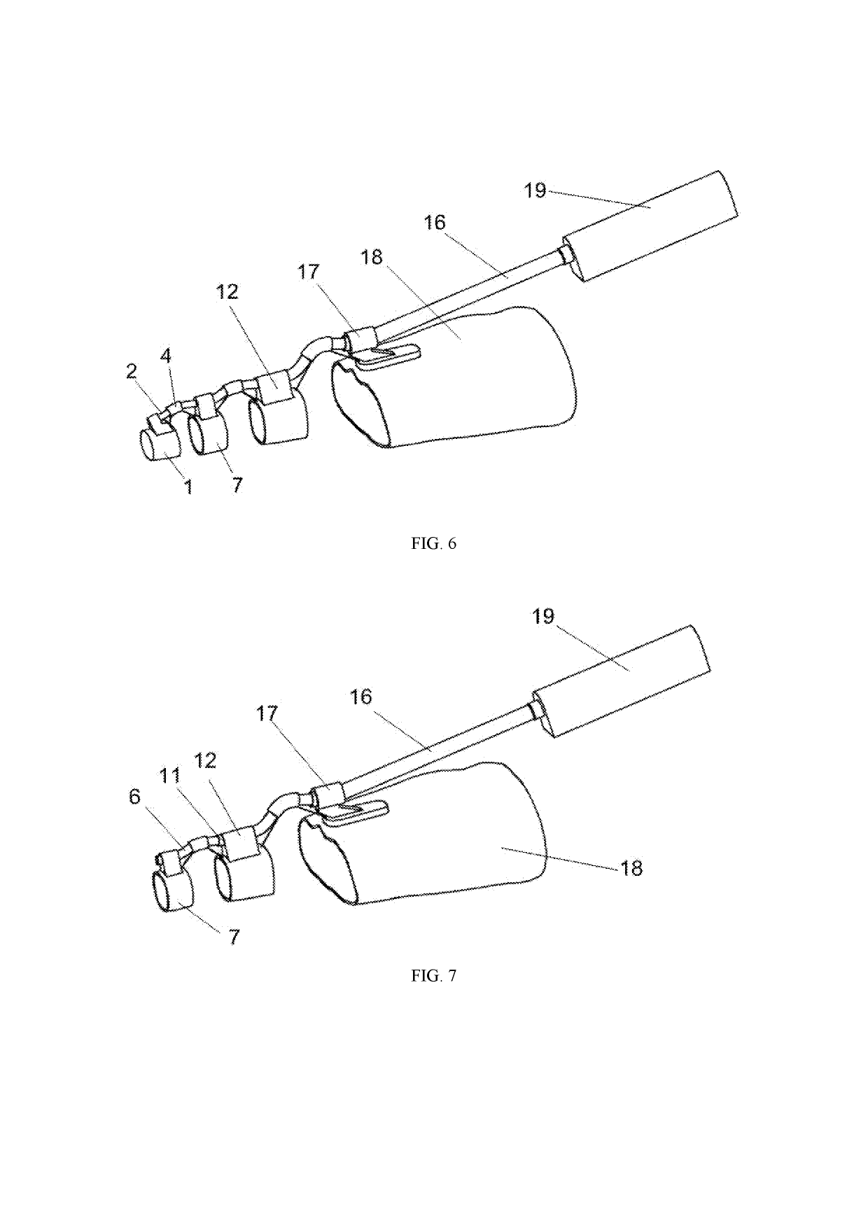

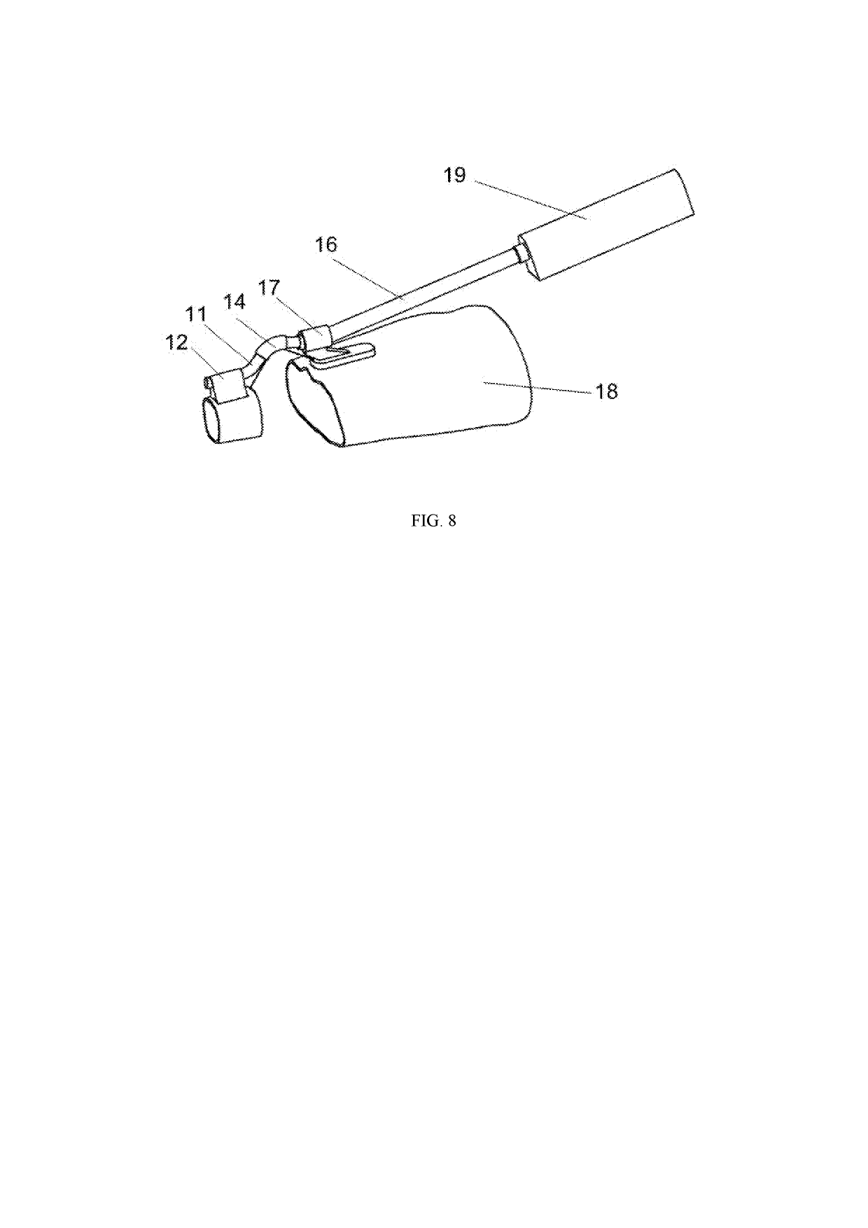

In some embodiments, the elastic driving member may include one or a combination of an elastic driving rod 2, a first elastic driving tube 6, and a second elastic driving tube 11. For example, as shown in FIG. 6, the elastic driving member only includes the elastic driving rod 2, where the elastic driving rod 2 drives the distal finger joint to bend, thereby driving the entire finger to bend. As shown in FIG. 7, the elastic driving member does not include the elastic driving rod 2. In this case, the first elastic driving tube 6 is replaced with a solid elastic driving rod to facilitate driving control of flexion and extension of the middle finger joint and the proximal finger joint. As shown in FIG. 8, the elastic driving member does not include the elastic driving rod 2 and the first elastic driving tube 6. In this case, the second elastic driving tube 11 is replaced with a solid elastic driving rod to facilitate driving control of flexion and extension of the proximal finger joint.

The specific process in which the finger rehabilitation device according to the present disclosure drives finger flexion and extension is specifically described below with reference to the accompanying drawings:

First, the driving box 19 synchronously drives the elastic driving rod 2, the first elastic driving tube 6, and the second elastic driving tube 11 to extend, such that the curve length between the palm connection assembly 17 and the proximal finger joint fixing seat 12 is increased, and the elastic driving rod 2, the first elastic driving tube 6, and the second elastic driving tube 11 deform, and bend and rotate towards the palm, thereby driving the proximal finger joint to flex and rotate around the palm.

Next, the driving box 19 synchronously drives the elastic driving rod 2 and the first elastic driving tube 6 to extend, such that the curve length between the proximal finger joint fixing seat 12 and the middle finger joint fixing seat 7 is increased, and the elastic driving rod 2 and the first elastic driving tube 6 deform, and bend and rotate towards the palm, thereby driving the middle finger joint to flex and rotate around the proximal finger joint.

Then, the driving box 19 drives the elastic driving rod 2 to extend, such that the curve length between the middle finger joint fixing seat 7 and the distal finger joint fixing seat 1 is increased, and the elastic driving rod 2 deforms, and bends and rotates toward the palm, thereby driving the distal finger joint to flex and rotate around the middle finger joint.

The process of finger extension driven by the finger rehabilitation device according to the present disclosure is opposite to the above-mentioned finger flexion process. First, the driving box 19 synchronously drives the elastic driving rod 2, the first elastic driving tube 6, and the second elastic driving tube 11 to retract, such that the curve length between the palm connection assembly 17 and the proximal finger joint fixing seat 12 is reduced, and the elastic driving rod 2, the first elastic driving tube 6, and the second elastic driving tube 11 deform, and bend and rotate away from the palm, thereby driving the proximal finger joint to extend and rotate around the palm.

Next, the driving box 19 synchronously drives the elastic driving rod 2 and the first elastic driving tube 6 to retract, such that the curve length between the proximal finger joint fixing seat 12 and the middle finger joint fixing seat 7 is reduced, and the elastic driving rod 2 and the first elastic driving tube 6 deform, and bend and rotate away from the palm, thereby driving the middle finger joint to extend and rotate around the proximal finger joint.

Then, the driving box 19 drives the elastic driving rod 2 to retract, such that the curve length between the middle finger joint fixing seat 7 and the distal finger joint fixing seat 1 is reduced, and the elastic driving rod 2 deforms, and bends and rotates away from the palm, thereby driving the distal finger joint to extend and rotate around the middle finger joint.

A second aspect of the present disclosure provides a nested elastic member-driven hand rehabilitation device, including a plurality of nested elastic member-driven finger rehabilitation devices described above, where the plurality of finger rehabilitation devices are correspondingly mounted on different fingers. The number of finger rehabilitation devices can be adjusted according to the therapeutic requirements of a patient. For example, the number of finger rehabilitation devices may be two, respectively worn on the index finger and middle finger of the patient, or five, respectively worn on the five fingers of the patient.

The finger rehabilitation device and the hand rehabilitation device according to the present disclosure have the following beneficial effects:

(1) The finger rehabilitation device according to the present disclosure features a compact structure and light weight. Several such devices can be selected and combined into different hand rehabilitation devices according to the requirements of patients.

(2) The finger rehabilitation device according to the present disclosure has multiple degrees of freedom, which enables full flexion of the three finger joints and independent control over the flexion of each joint.

(3) The finger rehabilitation device according to the present disclosure is driven by the elastic member with a nested structure. The nested structure further contributes to a compact configuration and a reduced movement space of the finger rehabilitation device. The flexion and extension of the finger joint are achieved by the same elastic driving member, and the driving displacement of the elastic driving member is identical, so the number of driving motors is reduced and control is simplified. Moreover, the two fixing seats of the finger are connected entirely by the elastic member, which can generate corresponding deformation for rotation around the finger joint as well as deformation perpendicular to the rotation direction. Thus, a certain degree of abduction and adduction between the fingers is allowed, and the comfort during movement is enhanced while reducing the requirements for wearing.

(4) The elastic driving rod, the first elastic driving tube, and the second elastic driving tube according to the present disclosure are all made of polytetrafluoroethylene with low cost and a low friction coefficient, which has the advantages of light weight, good elasticity, easy shaping, excellent fatigue strength, and the like; and the connection is simple, so the finger rehabilitation device obtained according to the mechanism is light in weight and low in manufacturing cost.

(5) The finger rehabilitation device according to the present disclosure has a small movement space and, due to the small number of members and simple connection, five finger rehabilitation devices can be arranged on the hand to independently control movement of the five fingers. Therefore, the hand rehabilitation device composed of five finger rehabilitation devices can achieve more hand postures compared with that in the prior art.

(6) The centerlines of the middle joint mounting hole, the proximal joint mounting hole, and the proximal finger joint mounting hole are in an arc shape, with a center located on the side close to the back of the hand, thereby preventing the elastic driving member from deforming towards the back of the finger and pressing against the finger.

The preferred embodiments of the present disclosure have been described in detail above with reference to the accompanying drawings. However, the present disclosure is not limited thereto. Within the scope of the technical concept of the present disclosure, various simple modifications can be made to the technical solutions of the present disclosure, including the combination of various specific technical features in any suitable manner. To avoid unnecessary repetition, the present disclosure does not separately describe all possible combinations. However, these simple modifications and combinations should also be regarded as the contents of the present disclosure and all fall within the scope of protection of the present disclosure.

What is claimed is:

1. A nested elastic member-driven finger rehabilitation device, comprising:
an elastic driving member, disposed on one side close to the back of a hand and capable of telescopic and flexion-extension movements;
a palm connection assembly, configured to be connected to a palm and the elastic driving member; and
a finger joint connection assembly, configured to be connected to a finger joint and the elastic driving member,
wherein the elastic driving member has the following working states:
a bending state, in which the elastic driving member extends to increase a curve length between the palm connection assembly and the finger joint connection assembly, and the elastic driving member bends toward the palm; and
an extension state, in which the elastic driving member retracts to shorten the curve length between the palm connection assembly and the finger joint connection assembly, and the elastic driving member extends away from the palm;
the finger joint connection assembly comprises a distal finger joint fixing seat connected to the elastic driving member and a distal finger joint, a middle finger joint fixing seat connected to the elastic driving member and a middle finger joint, and a proximal finger joint fixing seat connected to the elastic driving member and a proximal finger joint;
the elastic driving member comprises a first elastic driving member with an end connected to the distal finger joint fixing seat, a second elastic driving member with an end connected to the middle finger joint fixing seat, and a third elastic driving member with an end connected to the proximal finger joint fixing seat;
the first elastic driving member is an elastic driving rod, the second elastic driving member is a first elastic driving tube sleeved on the elastic driving rod, and the third elastic driving member is a second elastic driving tube sleeved on the first elastic driving tube; and
the middle finger joint fixing seat, the proximal finger joint fixing seat, and the palm connection assembly are respectively provided with a middle joint mounting hole, a proximal joint mounting hole, and a proximal finger joint mounting hole for mounting the elastic driving member, and centerlines of the middle joint mounting hole, the proximal joint mounting hole, and the proximal finger joint mounting hole are all in an arc shape, with a center located on the side close to the back of the hand.

2. The nested elastic member-driven finger rehabilitation device according to claim 1, wherein the middle joint mounting hole, the proximal joint mounting hole, and the proximal finger joint mounting hole are rotatably connected to the elastic driving member.

3. The nested elastic member-driven finger rehabilitation device according to claim 1, further comprising an elastic telescopic assembly sleeved on the elastic driving member, wherein the elastic telescopic assembly comprises a first elastic telescopic member disposed between the distal finger joint fixing seat and the middle finger joint fixing seat, a second elastic telescopic member disposed between the middle finger joint fixing seat and the proximal finger joint fixing seat, and a third elastic telescopic member disposed between the proximal finger joint fixing seat and the palm connection assembly.

4. The nested elastic member-driven finger rehabilitation device according to claim 3, further comprising a rope assembly, with one end connected to the palm connection assembly or the finger joint connection assembly, and the other end connected to one side of the elastic telescopic assembly close to a finger surface.

5. The nested elastic member-driven finger rehabilitation device according to claim 1, further comprising a driving box in transmission connection with the elastic driving member, and an elastic connecting tube connected between the driving box and the palm connection assembly, wherein the elastic connecting tube is sleeved on the elastic driving member.

6. The nested elastic member-driven finger rehabilitation device according to claim 1, wherein the elastic driving member is made of polytetrafluoroethylene.

7. A nested elastic member-driven hand rehabilitation device, comprising a plurality of nested elastic member-driven finger rehabilitation devices according to claim 1, wherein the plurality of finger rehabilitation devices are correspondingly mounted on different fingers.
